(19) United States
(12) Patent Application Publication
(10) Pub. No.: US 2026/0241932 A1
(43) Pub. Date: Aug. 20, 2026

(54) ELECTRIFIED VEHICLE AND A CONTROL METHOD THEREOF

(71) Applicants: HYUNDAI MOTOR COMPANY, Seoul (KR); KIA CORPORATION, Seoul (KR)

(72) Inventor: Jin Kyeom Cho, Hwaseong-si (KR)

(73) Assignees: HYUNDAI MOTOR COMPANY, Seoul (KR); KIA CORPORATION, Seoul (KR)

(21) Appl. No.: 19/294,607

(22) Filed: Aug. 8, 2025

(30) Foreign Application Priority Data
Feb. 17, 2025 (KR) 10-2025-0020193

(51) Int. Cl. B60W 30/18; B60L 15/20; B60W 10/08; B60W 10/20

(52) U.S. Cl. CPC B60W 30/18027; B60L 15/2036; B60L 15/2072; B60W 10/08; B60W 10/20; B60L 2240/423; B60L 2240/64; B60W 2510/20; B60W 2520/10; B60W 2540/215; B60W 2552/20; B60W 2554/20; B60W 2554/4041; B60W 2555/60; B60W 2556/45; B60W 2710/083; B60W 2710/20; B60W 2720/106; B60W 2720/406

(57) ABSTRACT

An electrified vehicle includes a vehicle speed profile generation unit, a steering profile generation unit, and a control unit. The vehicle speed profile generation unit generates, in a launch mode related to turning of a vehicle, a vehicle speed profile of the vehicle based on a vehicle speed limit of a road ahead and an upper limit value of an acceleration of the vehicle. The steering profile generation unit generates a steering profile of the vehicle based on curvature information on the road ahead. The control unit performs a torque control of a drive motor of the vehicle based on the vehicle speed profile and a steering control of the vehicle based on the steering profile. The control unit performs the torque control and the steering control from a starting point at which the vehicle starts acceleration to an ending point at which the vehicle reaches the vehicle speed limit.

### CROSS-REFERENCE TO THE RELATED APPLICATION

This application claims priority to Korean Patent Application No. 10-2025-0020193, filed on, Feb. 17, 2025, in the Korean Intellectual Property Office, the disclosure of which is incorporated herein by reference in its entirety.

### BACKGROUND

### 1. Field of the Disclosure

The present disclosure relates to an electrified vehicle having a launch mode (acceleration mode) related to turning and a control method thereof.

### 2. Description of the Related Art

As interest in environment has increased in recent years, the number of eco-friendly vehicles equipped with an electric motor as a power source is increasing. Such an eco-friendly vehicle is also called an electrified vehicle. Representative electrified vehicles include hybrid vehicles (HEVs) and electric vehicle (EVs).

The electrified vehicle has constant torque characteristics capable of outputting a maximum torque until rotations per minute (RPM) of a motor reaches a certain value where a counter electromotive force becomes strong, thereby achieving excellent initial acceleration performance (standing-start acceleration ability) compared to an internal combustion engine vehicle. This acceleration performance may be maximized when starting from a stopped state, but it may be difficult to fully utilize the acceleration performance on a public road or a curved section (e.g., curved road section) where there is a speed limit.

The above information disclosed in the Background section is provided only to enhance understanding of the background of the disclosure. Therefore, inclusion of the above information in the Background section is not an acknowledgement that the disclosed is prior art that is already known to those of ordinary skill in the art.

### SUMMARY

The present disclosure has been made in view of the above problems, and it is an object of the present disclosure to provide an electrified vehicle having a launch mode related to turning, and a control method thereof.

It is another object of the present disclosure to provide an electrified vehicle capable of generating a vehicle speed profile by taking into account a vehicle speed limit and traffic situation information on a road ahead, and a control method thereof.

It is a further object of the present disclosure to provide an electrified vehicle capable of torque vectoring control for a stable turning operation in a launch mode related to turning, and a control method thereof.

The objects of the present disclosure are not limited to the above-mentioned objects. Other objects achieved by the present disclosure not mentioned above should be clearly understood by those of ordinary skill in the art from the following description.

In accordance with the present disclosure, the above and other objects can be accomplished by the provision of an electrified vehicle including: a vehicle speed profile generation unit that generates, in a launch mode related to turning of a vehicle, a vehicle speed profile of the vehicle based on a vehicle speed limit of a road ahead and a upper limit value of acceleration of the vehicle; a steering profile generation unit that generates a steering profile of the vehicle based on curvature information on the road ahead; and a control unit that performs torque control of a drive motor of the vehicle based on the vehicle speed profile and steering control of the vehicle based on the steering profile. The control unit performs the torque control and the steering control from a starting point at which the vehicle starts acceleration to an ending point at which the vehicle reaches the vehicle speed limit.

The control unit may further perform torque vectoring control based on a steering tendency of the vehicle for differentiating a left-wheel torque and a right-wheel torque in a direction in which the steering tendency is offset.

The torque vectoring control may be performed based on the vehicle reaching a preset torque vectoring vehicle speed.

The steering profile generation unit may generate a final steering profile of the vehicle based on the steering profile and the torque vectoring vehicle speed.

The preset torque vectoring vehicle speed may be set to be less than a characteristic speed at which a steering angle of the vehicle is twice a steering angle during neutral steering.

The electrified vehicle may further include a launch mode determination unit that determines whether the launch mode is executable based on route information on the road ahead, situation information on the road ahead, and a vehicle speed limit of the road ahead.

The launch mode determination unit may determine that the launch mode is executable based on an accelerable distance according to the situation information being greater than a preset distance and the vehicle speed limit being greater than a preset vehicle speed.

The situation information may include at least one of forward traffic information received from an external source or forward obstacle information received through a sensor, and wherein the preset distance and the preset vehicle speed may be set based on a minimum distance and a minimum vehicle speed necessary for reaching a specific speed based on the vehicle accelerating from a stopped state.

The vehicle speed profile generation unit may generate the vehicle speed profile so that an integral value of a vehicle speed in the vehicle speed profile from a starting point at which the vehicle starts acceleration in the launch mode to an ending point of the launch mode does not exceed the accelerable distance.

The electrified vehicle may further include an input/output unit that is configured to output information indicating that the launch mode is executable based on the launch mode determination unit determining that the launch mode is executable, and configured to receive a driver's request to execute the launch mode.

In accordance with another aspect of the present disclosure, there is provided a control method of an electrified vehicle including: generating, by a vehicle profile generation unit in a launch mode related to turning of a vehicle, a vehicle speed profile of the vehicle based on a vehicle speed limit of a road ahead and an upper limit value of acceleration of the vehicle; generating by a steering profile generation unit a steering profile of the vehicle based on curvature information on the road ahead; and performing torque control of a drive motor of the vehicle based on the vehicle speed profile and a steering control of the vehicle based on the steering profile. The torque control and the steering control are performed by a control unit from a starting point at which the vehicle starts acceleration to an ending point at which the vehicle reaches the vehicle speed limit.

The control method may further include performing torque vectoring control for differentiating based on a steering tendency of the vehicle a left-wheel torque and a right-wheel torque in a direction in which the steering tendency is offset.

The performing the torque vectoring control may be performed based on the vehicle reaching a preset torque vectoring vehicle speed.

The control method may further include generating, by the steering profile generation unit, a final steering profile of the vehicle based on the steering profile and the torque vectoring vehicle speed after the torque vectoring vehicle speed is determined.

The preset torque vectoring vehicle speed may be set to be less than a characteristic speed at which a steering angle of the vehicle is twice a steering angle during neutral steering.

The control method may further include determining whether the launch mode is executable based on route information on the road ahead, situation information on the road ahead, and a vehicle speed limit of the road ahead.

The determining whether or not the launch mode is executable may include determining that the launch mode is executable based on an accelerable distance according to the situation information being greater than a preset distance and the vehicle speed limit being greater than a preset vehicle speed.

The situation information may include at least one of forward traffic information received from a source external to the electrified vehicle or forward obstacle information received through a sensor, and wherein the preset distance and the preset vehicle speed may be set based on a minimum distance and a minimum vehicle speed necessary for reaching a specific speed based on the vehicle accelerating from a stopped state.

The generating the vehicle speed profile may include generating the vehicle speed profile so that an integral value of a vehicle speed on the vehicle speed profile from a starting point at which the vehicle starts acceleration in the launch mode to an ending point of the launch mode does not exceed the accelerable distance.

The control method may further include outputting information indicating that the launch mode is executable based on the launch mode determination unit determining that the launch mode is executable, and receiving a driver's request to execute the launch mode, by the input/output unit.

### BRIEF DESCRIPTION OF THE DRAWINGS

The above and other objects, features, and other advantages of the present disclosure should be more clearly understood from the following detailed description taken in conjunction with the accompanying drawings, in which:

FIG. 1 is a diagram for describing an electrified vehicle according to an embodiment of the present disclosure;

FIG. 2 is a diagram for describing a control unit according to an embodiment of the present disclosure;

FIG. 3 is a diagram illustrating a launch mode related to turning in an electrified vehicle according to an embodiment of the present disclosure;

FIG. 4 is a diagram showing an example of a launch mode output of an AVNT terminal according to an embodiment of the present disclosure;

FIG. 5 is a diagram showing an acceleration profile of a launch mode according to an embodiment of the present disclosure;

FIG. 6 is a diagram showing a vehicle speed profile corresponding to an acceleration profile according to an embodiment of the present disclosure;

FIG. 7 is a diagram showing an acceleration-distance graph corresponding to a vehicle speed profile according to an embodiment of the present disclosure;

FIGS. 8 and 9 are diagrams illustrating understeer, neutral steer and oversteer in an electrified vehicle according to an embodiment of the present disclosure;

FIGS. 10 and 11 are diagrams illustrating a torque vectoring control according to an embodiment of the present disclosure; and

FIG. 12 is a flowchart showing a control process of a launch mode related to turning according to an embodiment of the present disclosure.

### DETAILED DESCRIPTION OF THE EMBODIMENTS

The following specific structural or functional descriptions of embodiments of the present disclosure are merely provided as examples for the purpose of describing the embodiments according to the present disclosure, and the embodiments according to the present disclosure may be implemented in various other forms.

Reference is made in detail to various embodiments of the present disclosure, examples of which are illustrated in the accompanying drawings and described below. The present description is not intended to limit the disclosure to the embodiments described herein, and various alternatives, modifications, and equivalents, and other embodiments should be interpreted as being within the spirit and scope of the present disclosure.

Unless clearly defined otherwise, terms used herein, including technical or scientific terms have the same meaning as understood by those of ordinary skill in the art. Terms defined in commonly used dictionaries should be interpreted as having meanings consistent with meanings in the context of the related technology, and unless clearly defined in this specification, should not be interpreted as having ideal or excessively formal meanings.

Hereinafter, reference is made in detail to various embodiments of the present disclosure, examples of which are illustrated in the accompanying drawings. Wherever possible, the same reference numbers have been used throughout the drawings to refer to the same or like parts.

In the description of the following embodiments, the term “preset” means that, in a case where a parameter is used in a process or algorithm, a value of the parameter is set or determined in advance. Depending on the embodiments, the value of the parameter may be set when the process or algorithm starts, or may be set during a section in which the process or algorithm is performed.

The suffixes “module” and “unit” for components used in the following description are given or used interchangeably only for ease of description of the specification, and do not have distinct meanings or roles in themselves.

In describing the embodiments, detailed descriptions of related known technologies have been omitted as necessary. It should be understood that the accompanying drawings are given hereinafter by way of illustration only and are not limitative of the disclosure, and the present disclosure is intended to cover various alternatives, modifications, equivalents and other embodiments, within the spirit and scope of the disclosure as defined by the appended claims.

It should be understood that, although the terms “first”, “second”, etc. may be used herein to describe various elements, these elements should not be limited by these terms. These terms are only used to distinguish one element from another.

Further, it should be understood that, when an element is “connected” or “coupled” to another element, it may be directly connected or coupled to the other element, or may be indirectly connected or coupled to the other element with a different element being interposed therebetween. In contrast, when an element is “directly connected” or “directly coupled” to another element, this means that there is no intervening element therebetween.

As used herein, the singular forms “a”, “an”, and “the” are intended to include the plural forms as well, unless the context clearly indicates otherwise.

It should be further understood that the terms “comprise”, “include”, and “have” used herein merely specify the presence of stated features, numbers, steps, operations, components, parts, or combinations thereof, but do not preclude the presence or addition of one or more other features, numbers, steps, operations, components, parts, or combinations thereof.

In addition, a “unit” or a “control unit” included in names of a motor control unit (MCU), a hybrid control unit (HCU), and the like merely refers to a controller that controls specific vehicle functions, and does not refer to a generic functional unit. When a component, unit, controller, device, element, apparatus or the like of the present disclosure is described as having a purpose or performing an operation, function, or the like, the component, unit, controller, device, element, or apparatus should be considered herein as being “configured to” meet that purpose or perform that operation or function. Each component, unit, controller, device, element, apparatus, and the like may separately embody or be included with a processor and a memory, such as a non-transitory computer readable media, as part of the apparatus.

An electrified vehicle has excellent initial acceleration performance, compared with an internal combustion engine, due to constant torque characteristics of a drive motor. However, a driver may not fully use the acceleration performance due to a traffic situation of a road and a speed limit of the road.

A launch mode according to an embodiment of the present disclosure may include a launch control mode in a vehicle stop state which ensures safety under such a condition while allowing a driver to feel upper limit value of acceleration.

Such a launch mode may be provided to determine whether or not the launch mode is executable based on traffic situation information on a road ahead and a speed limit of the road ahead. The launch mode may further inform the driver whether the launch mode is executable, generate, in a case where the driver wants to execute the launch mode, an acceleration profile, and output a torque that follows the acceleration profile.

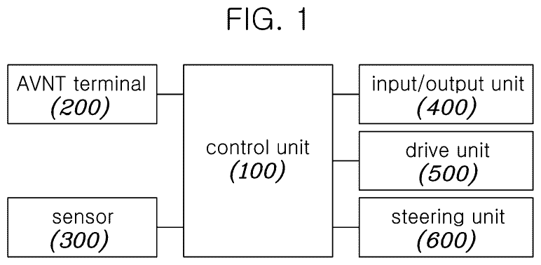

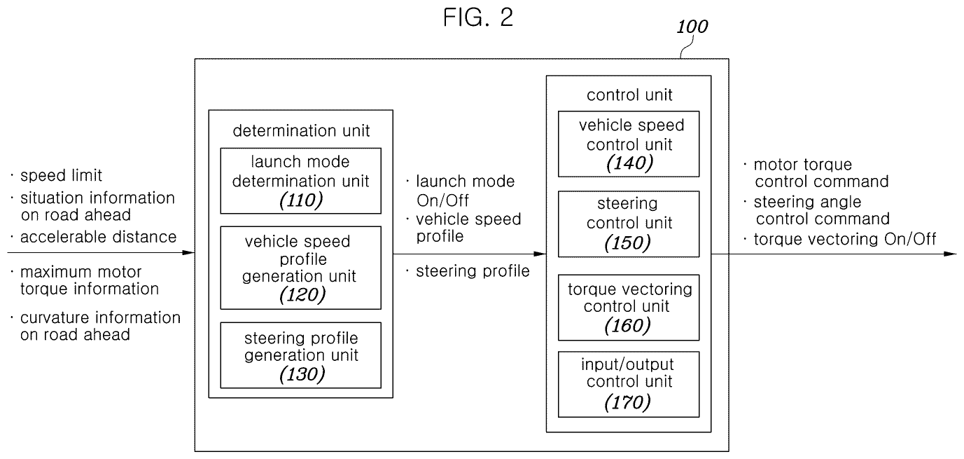

Hereinafter, a configuration of an electrified vehicle having such a launch mode is described with reference to FIGS. 1 and 2.

FIG. 1 is a diagram for describing an electrified vehicle according to an embodiment of the present disclosure.

Referring to FIG. 1, the electrified vehicle may include a control unit 100, an Audio/Video/Navigation/Telematics (AVNT) terminal 200, a sensor 300, an input/output unit 400, a drive unit 500, and a steering unit 600.

The control unit 100 may perform launch mode control of the electrified vehicle. For example, the control unit 100 may determine whether or not a launch mode related to turning is executable. Additionally, the control unit 100 may generate, upon receiving a request from a driver to execute the launch mode, a vehicle speed profile and a steering profile for the launch mode. Further, the control unit 100 may perform a torque control corresponding to the vehicle speed profile and a steering control corresponding to the steering profile. In this case, the control unit 100 that performs the launch mode control may be implemented as a vehicle control unit (VCU) that is an upper-level controller that collectively controls overall functions of the electrified vehicle. Alternatively, all or some of the launch mode control functions may be performed by an advanced driver assistance system (ADAS) control unit, a motor control unit (MCU), or the like.

The AVNT terminal 200 may obtain situation information on a road ahead and a vehicle speed limit of the road ahead. The AVNT terminal 200 may transmit the result to the control unit 100. Here, the situation information may include forward traffic information received from a source external to or outside the electrified vehicle (e.g., from a traffic information infrastructure server, a connected car service server, or the like) through a navigation function or telematics function. The vehicle speed limit may be acquired through the navigation function.

The sensor 300 may detect the presence and location (distance) of an obstacle such as a lead vehicle. For example, the sensor may be at least one of a RADAR sensor, a LIDAR sensor, or a camera, and may provide information about the detection result to the control unit 100.

The input/output unit 400 may indicate whether to enter the launch mode via a display, or the like, and may receive a driver's request to enter the launch mode through a control system such as a touchscreen, key buttons, or a dial. For example, the input/output unit 400 may include a cluster unit. Alternatively, the AVNT terminal 200 may be implemented to perform the functions of the input/output unit 400 as necessary.

The drive unit 500 may generate power for the vehicle. For example, the drive unit 500 may include an inverter that converts direct current (DC) power to alternating current (AC) power and a drive motor that generates power necessary for driving the vehicle based on the AC power.

The steering unit 600 may refer to a system that performs vehicle steering control and maintains stability of the vehicle during steering. For example, the steering unit 600 may include a steering wheel for a vehicle direction control by a driver, a Motor Driven Power Steering (MDPS), for assisting the driver in steering via an electric motor, and the like.

FIG. 2 is a diagram for describing a control unit according to an embodiment of the present disclosure.

The control unit 100 may perform motor torque control, steering angle control, and torque vectoring control of the vehicle based on a vehicle speed limit, forward road situation information, maximum motor torque information on the vehicle, an accelerable distance, forward road curvature information, and the like. In this case, the control unit 100 may include determination units 110, 120 and 130 that determine whether the launch mode is executable in a vehicle stop state, a vehicle speed profile and a steering profile to be performed in the launch mode, and the like. The control unit 100 may further include control units 140, 150, 160 and 170 (e.g., control sub-units 140, 150, 160, 170) that control the launch mode according to the determination results of the determination units 110, 120 and 130 and a driver's launch mode execution command.

Here, the determination units 110, 120, and 130 may include a launch mode determination unit 110, a vehicle speed profile generation unit 120, and a steering profile generation unit 130. the control sub-units or control units 140, 150, 160, and 170 may include a vehicle speed control unit 140, a steering control unit 150, a torque vectoring control unit 160, and an input/output control unit 170.

The launch mode determination unit 110 may determine whether or not the launch mode is executable in a vehicle stop state, based on situation information on the road ahead and a vehicle speed limit of the road ahead.

Specifically, the launch mode determination unit 110 may determine that the launch mode is executable based on the accelerable distance according to the situation information being greater than a preset distance and the vehicle speed limit being greater than a preset vehicle speed.

Here, the preset distance may refer to a minimum distance necessary for reaching a specific acceleration when the vehicle accelerates from the vehicle stop state. The preset vehicle speed may refer to a minimum vehicle speed necessary to reach the specific acceleration when the vehicle accelerates from the stopped state.

Here, the accelerable distance may refer to a distance that a vehicle in a stopped state can travel forward in the launch mode. For example, the launch mode determination unit 110 may determine the accelerable distance based on situation information including at least one of forward road traffic information or forward road curvature information acquired through the AVNT terminal 200, or forward obstacle information received through the sensor 300.

Here, the conditions for determining whether to execute the launch mode by the launch mode determination unit 110 are provided by way of example and are not necessarily limited to the above-mentioned conditions. For example, the launch mode determination unit 110 may determine whether to execute the launch mode by further taking into account the curvature of the road ahead, a normal or abnormal status of the vehicle system, the accelerable distance information, and/or the vehicle speed limit, instead of or in addition to the above-mentioned conditions.

In addition, the launch mode may include a launch mode related to turning. In this case, the launch mode determination unit 110 may determine whether or not the launch mode related to turning is executable based on route information on a road ahead, situation information on the road ahead, and a vehicle speed limit of the road ahead. Here, the situation information on the road ahead may include curvature information on a road ahead in a vehicle stop state and traffic information on the road ahead.

The vehicle speed profile generation unit 120 may generate, based on a maximum torque, a vehicle speed limit and an acceleration profile of the vehicle, and a vehicle speed profile from a starting point at which the vehicle starts acceleration in the launch mode to an ending point at which the vehicle reaches the vehicle speed limit.

Here, the acceleration profile corresponding to the vehicle speed profile may be set such that the acceleration increases from the point at which the launch mode starts to a point at which the vehicle reaches the upper limit value of acceleration of the vehicle, and decreases from the point at which the vehicle reaches the upper limit value of acceleration to the ending point of the launch mode. With this type of acceleration profile, it is possible for the driver to feel the upper limit value of acceleration of the vehicle. Further, it is possible to decrease the acceleration at the end of control, thereby reducing the risk of exceeding the vehicle speed limit.

For example, the acceleration profile may be set to correspond to a cubic equation graph as expressed by Equation 1. Here, y represents acceleration, x represents time, a represents an inclination of an acceleration profile, which is greater than 0, b represents an ending point at which the acceleration profile ends, and c represents an upper limit value of acceleration, respectively.

$$y = - {a ( x - b )}^{3} + c \qquad [ Equation 1 ]$$

Here, the acceleration profile is not necessarily limited to the form of Equation 1. For example, the acceleration profile may be set to correspond to part of another form of N-order function showing a form such that the acceleration increases and then decreases.

Further, the vehicle speed profile generation unit 120 may determine the upper limit value of acceleration of the vehicle based on the maximum torque that can be generated by the vehicle system. Specifically, the upper limit value of acceleration (α) of the vehicle may be determined according to Equation 2 based on torque (Tq_{wheel}) applied to a wheel of the vehicle, a moment of inertia (Jₜₒₜₐₗ) of the vehicle, and a moving radius (R_{wheel}) of the wheel.

$$α = \frac{T {q}_{w h e e l}}{{J}_{total}} {R}_{w h e e l} \qquad [ Equation 2 ]$$

Here, the upper limit value of acceleration is not necessarily limited to the maximum acceleration according to the vehicle's specifications, but may be set differently in consideration of initial performance of the vehicle and durability of the motor.

The steering profile generation unit 130 may generate a steering profile of the vehicle based on forward road curvature information. Here, the steering profile generation unit 130 may create a final steering profile by further considering a torque vectoring vehicle speed in the steering profile. For example, the steering profile generation unit 130 may generate the steering profile for driving on a forward curved road according to Equation 3. Here, δ_{f} represents a steering angle of front wheels required when the vehicle is turning, L represents a wheelbase of the vehicle, R is a turning radius, W_{f} represents a load applied to a front axle of the vehicle, Wᵣ represents a load applied to a rear axle of the vehicle, C_{af} represents a cornering stiffness of the front wheel of the vehicle, Cₐᵣ represents a cornering stiffness of the rear wheel of the vehicle, V represents a vehicle speed, and g represents acceleration due to gravity.

$${δ}_{f} = 57.3 \frac{L}{R} + ( \frac{{W}_{f}}{{C}_{a f}} - \frac{{W}_{r}}{{C}_{a r}} ) \frac{{V}^{2}}{g R} \qquad [ Equation 3 ]$$

The vehicle speed control unit 140 may perform torque control of a drive motor based on the vehicle speed profile. For example, the vehicle speed control unit 140 may transmit a torque control command to the inverter in the drive unit 500 based on the acceleration profile or the vehicle speed profile generated in the vehicle speed profile generation unit 120 to control an output torque of the drive motor.

The steering control unit 150 may perform steering control of the vehicle based on the steering profile. For example, the steering control unit 150 may transmit a steering angle control command to an MDPS of the steering unit 600 based on the steering profile generated by the steering profile generation unit 130.

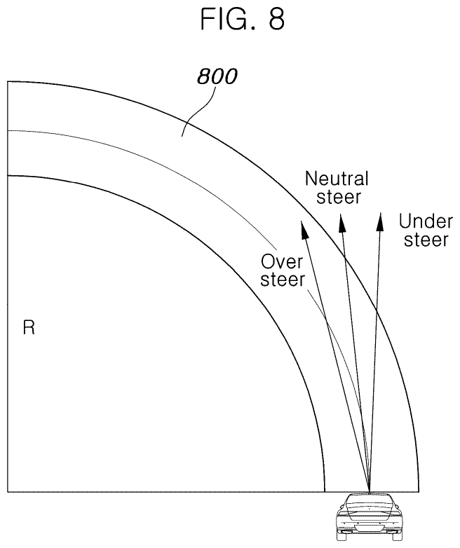

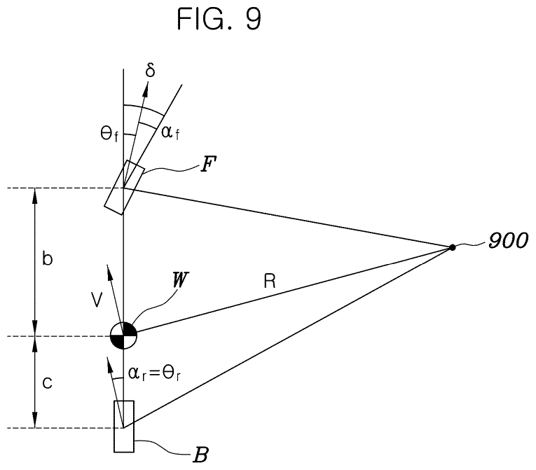

The torque vectoring control unit 160 may differentiate the left-wheel torque and the right-wheel torque, based on a steering tendency of the vehicle, in a direction in which the steering tendency of the vehicle is offset. Here, the torque vectoring control unit 160 may perform the torque vectoring control from a time when the vehicle speed reaches a preset torque vectoring vehicle speed. Detailed description of the torque vectoring vehicle speed have been made with reference to FIGS. 8-11.

In a case where the launch mode determination unit 110 determines that the launch mode is executable, the input/output control unit 170 may output information indicating that the launch mode is executable to the input/output unit 400. The input/output control unit 170 may receive a driver's request to perform the launch mode through the input/output unit 400. For example, based on the driver's request to perform the launch mode through the input/output unit 400, the input/output control unit 170 may transmit a control command to the vehicle speed profile generation unit 120 to generate the vehicle speed profile.

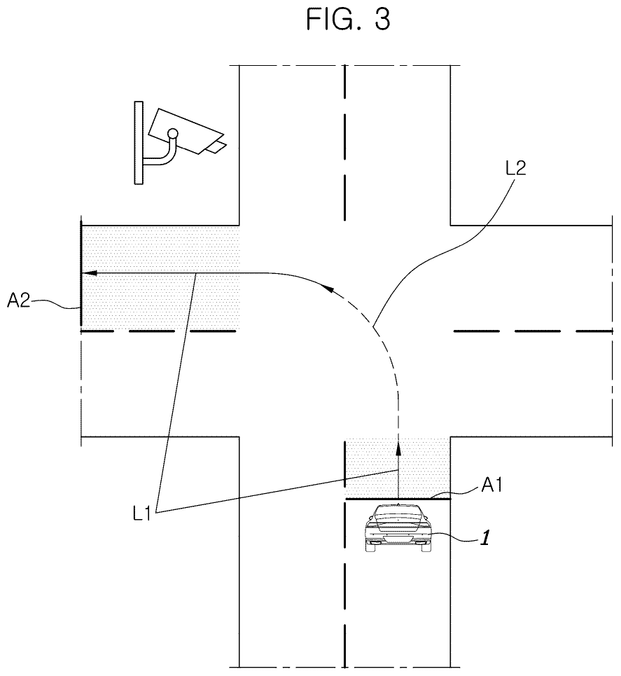

FIG. 3 is a diagram illustrating a launch mode related to turning in an electrified vehicle according to an embodiment of the present disclosure.

Referring to FIG. 3, there is no other vehicle in front of the electrified vehicle 1, and the electrified vehicle 1 stops at a starting point (A1) of a road where straight sections (L1) and a curved section (L2) with a curvature of 1/R.

In a case where the electrified vehicle 1 is stopped at the starting point (A1), the launch mode determination unit 110 may determine whether to execute the launch mode based on forward road situation information of the electrified vehicle 1 and a vehicle speed limit of the road ahead.

In addition, in a case where a determination is made that the launch mode is executable and the driver's request to execute the launch mode is received, the electrified vehicle 1 may travel in the launch mode from the starting point (A1) to an ending point (A2).

In the launch mode, the electrified vehicle 1 may perform torque control of the drive motor based on the vehicle speed profile and the steering control of the vehicle according to the vehicle's steering profile generated based on curvature information of the curved section (L2) on the road ahead.

In this case, a launch mode driving distance from the starting point (A1) to the ending point (A2) where the vehicle travels in the launch mode corresponds to a value that is equal to or less than the accelerable distance, which may be determined based on the vehicle speed profile generated by the vehicle speed profile generation unit 120.

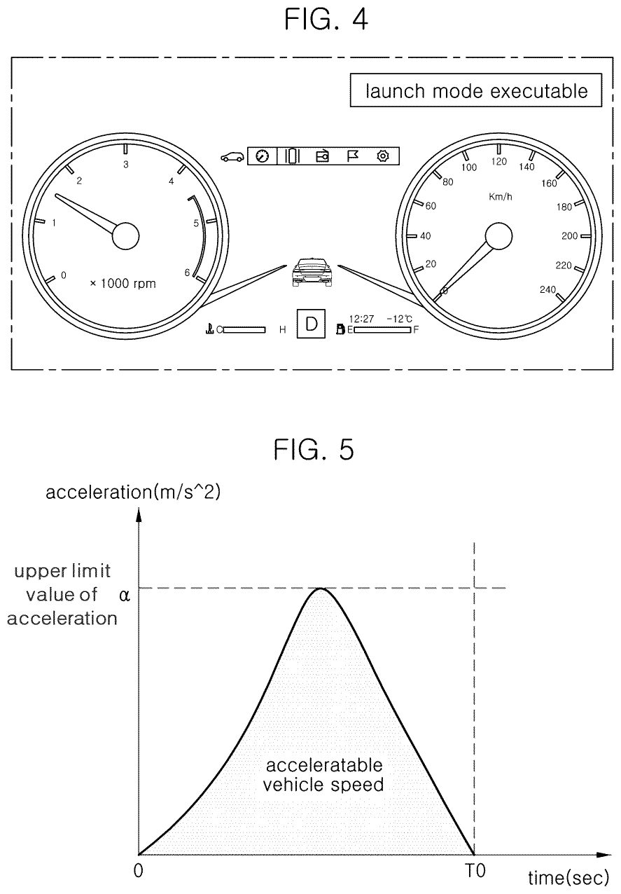

FIG. 4 is a diagram showing an example of a launch mode output of an AVNT terminal according to an embodiment of the present disclosure.

Referring to FIG. 4, a message 410 indicating that the launch mode is executable is displayed on the cluster unit of the input/output unit 400.

In a case where the launch mode determination unit 110 determines that the launch mode is executable based on the situation information on the road ahead and the vehicle speed limit of the road ahead in the vehicle stop state, the input/output control unit 140 may output the message 410 indicating that the launch mode is executable on the cluster unit of the input/output unit 400. Here, the driver may touch an area where the message 410 is output on the cluster screen of the input/output unit 400, or may operate a button provided on the steering wheel or the like to transmit the launch mode execution request to the input/output control unit 140.

FIG. 5 is a diagram showing an acceleration profile of a launch mode according to an embodiment of the present disclosure.

Referring to FIG. 5, an acceleration profile graph of the electrified vehicle 1 is shown in the launch mode from a starting point (0) at which the vehicle starts acceleration in the launch mode to an ending point (T0) at which the vehicle reaches the vehicle speed limit.

The acceleration profile graph may have such a schematic form that the acceleration of the vehicle increases from the starting point (0) at which the launch mode starts to a point at which the vehicle reaches a upper limit value of acceleration (α) and decreases from the upper limit value of acceleration (α) to the ending point (T0) of the launch mode.

Since the acceleration profile according to the launch mode may be generated in a case where the vehicle is stopped, the starting point (0) may correspond to the origin (0, 0) of the acceleration profile graph, and the ending point (T0) of the launch mode may be set to a point at which the acceleration on the acceleration profile graph corresponds to zero. For example, in a case where the acceleration profile graph corresponds to the cubic function graph of Equation 1, the origin (0, 0) may correspond to the starting point (0) of the acceleration profile graph, and b where the +x axis and the acceleration profile graph intersect may correspond to the ending point (T_0) of the launch mode.

In addition, an integral value of the acceleration of the acceleration profile graph for a time from the starting point (0) of the launch mode to the ending point (T0) of the launch mode may correspond to the vehicle speed of the electrified vehicle 1 at the ending point (T0) of the launch mode.

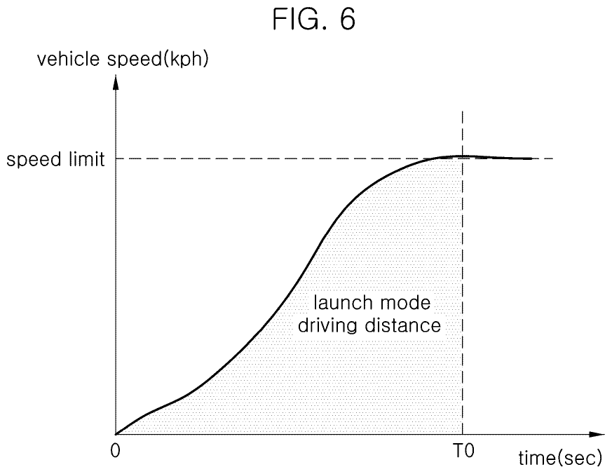

FIG. 6 is a diagram showing a vehicle speed profile corresponding to an acceleration profile according to an embodiment of the present disclosure.

Referring to FIG. 6, the vehicle speed profile graph corresponding to the acceleration profile from the starting point (0) at which the vehicle starts acceleration in the launch mode to the ending point (T0) at which the vehicle reaches the maximum vehicle speed in the launch mode is shown.

The vehicle speed profile graph is a vehicle speed graph over time obtained by integrating the acceleration graph in FIG. 5, which may have a maximum vehicle speed at the ending point (T0) of the launch mode. Here, the maximum vehicle speed in the launch mode may be set so as not to exceed the vehicle speed limit of the road ahead. In this case, even if the vehicle follows the acceleration profile of the launch mode, the maximum vehicle speed of the vehicle may not exceed the vehicle speed limit of the road ahead.

In addition, an integral value of the vehicle speed in the vehicle speed profile graph for the time from the starting point (0) of the launch mode to the ending point (T0) of the launch mode may correspond to a launch mode driving distance of the electrified vehicle 1 corresponding to the starting point (A1) of the launch mode to the ending point (A2) of the launch mode.

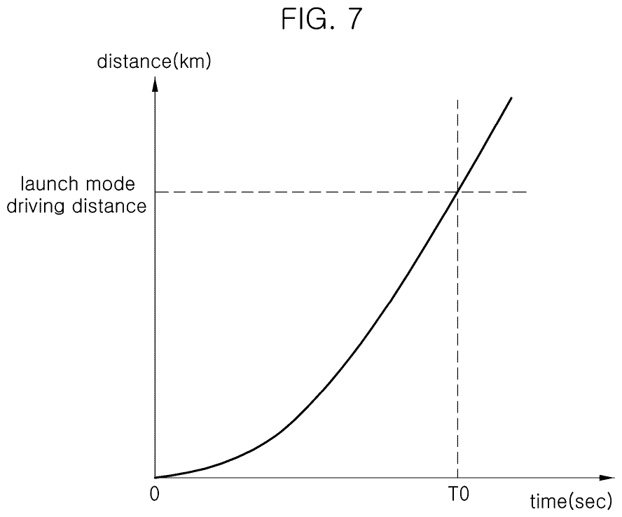

FIG. 7 is a diagram showing an acceleration-distance graph corresponding to a vehicle speed profile according to an embodiment of the present disclosure.

Referring to FIG. 7, a launch mode driving distance graph is shown corresponding to a launch mode acceleration profile from the starting point (0) at which the vehicle starts acceleration in the launch mode to the ending point (T0) at which the vehicle reaches the ending point (A2) of the launch mode.

The launch mode driving distance graph is a driving distance graph over time obtained by integrating the launch mode vehicle speed profile graph, which may have a maximum value at the ending point (T0) of the launch mode. Here, the maximum value of the driving distance graph may correspond to the driving distance in the launch mode.

FIGS. 8 and 9 are diagrams illustrating a steering tendency of the vehicle according to an embodiment of the present disclosure.

Referring to FIGS. 8 and 9, in order to describe the steering tendency, such as understeer, neutral steer and oversteer, a vehicle is shown traveling a curved section 800 that includes a portion of a circle with a distance (R) from the center of rotation 900, in which a center of gravity (W), a front wheel (F), a first distance (b) from the center of gravity (W) to the front wheel (F), a rear wheel (B), and a second distance (c) from the center of gravity (W) to the rear wheel (B) are shown.

In a case where the vehicle is traveling on the curved section 800, the vehicle's steering tendency, such as understeer, neutral steer and oversteer, may be determined based on a steering angle of the vehicle in response to a steering input received from the steering unit 600. Here, the steering angle for the vehicle to travel on the curved section 800 may be expressed by Equation 4. Here, δ_{f} represents a steering angle of a front wheel required when the vehicle is turning, L represents a wheelbase of the vehicle, R is a radius of turn, W_{f} represents a load applied to a front axle of the vehicle, Wᵣ represents a load applied to a rear axle of the vehicle, C_{af} represents a cornering stiffness of the front wheel of the vehicle, Cₐᵣ represents a cornering stiffness of the rear wheel of the vehicle, V represents a vehicle speed, and g represents acceleration due to gravity.

$${δ}_{f} = 57.3 \frac{L}{R} + ( \frac{{W}_{f}}{{C}_{a f}} - \frac{{W}_{r}}{{C}_{a r}} ) \frac{{V}^{2}}{g R} \qquad [ Equation 4 ]$$

The oversteer may mean that a rear-wheel slip angle (aᵣ) is greater than a front-wheel slip angle (a_{f}). In a case where a vehicle with an oversteer tendency is traveling on the curved section 800, a rear end portion of the vehicle may turn excessively in the direction of cornering, thereby resulting in an actual steering angle being greater than the driver's steering input.

The neutral steer may mean that the front-wheel slip angle (a_{f}) is similar to the rear-wheel slip angle (aᵣ). In a case where a vehicle with such an oversteer tendency travels on the curved section 800, the driver's steering input and an actual steering angle may be adjusted similarly.

The understeer may mean that the front-wheel slip angle (a_{f}) is greater than the rear-wheel slip angle (aᵣ). In a case where a vehicle with such an understeer tendency travels on the curved section 800, a front portion of the vehicle may not turn sufficiently in the direction of cornering, thereby resulting in the actual steering angle being smaller than the driver's steering input.

Here, the oversteer is expressed by Equation 5, the neutral steer is expressed by Equation 6, and the understeer is expressed by Equation 7. Here, a_{f} represents a front-wheel slip angle, aᵣ represents a rear-wheel slip angle, b represents a distance from the center of gravity to a front axle, c represents a distance from the center of gravity to a rear axle, W_{f} represents a load applied to the front axle, Wᵣ represents a load applied to the rear axle, C_{af} represents a cornering stiffness of a front wheel, and Cₐᵣ represents a cornering stiffness of a rear wheel.

$$( \frac{{W}_{f}}{{C}_{a f}} < \frac{{W}_{r}}{{C}_{a r}} ) or ( b \cdot {C}_{a f} > c \cdot {C}_{a r} ) , K < 0 , {a}_{f} < {a}_{r} \qquad [ Equation 5 ]$$

$$( \frac{{W}_{f}}{{C}_{a f}} - \frac{{W}_{r}}{{C}_{a r}} ) or ( b \cdot {C}_{a f} = c \cdot {C}_{a r} ) , K = 0 , {a}_{f} = {a}_{r} \qquad [ Equation 6 ]$$

$$( \frac{{W}_{f}}{{C}_{a f}} > \frac{{W}_{r}}{{C}_{a r}} ) or ( b \cdot {C}_{a f} < c \cdot {C}_{a r} ) , K > 0 , {a}_{f} > {a}_{r} \qquad [ Equation 7 ]$$

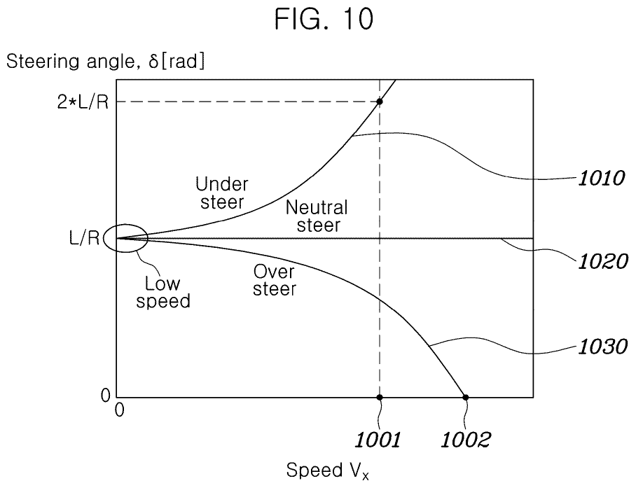

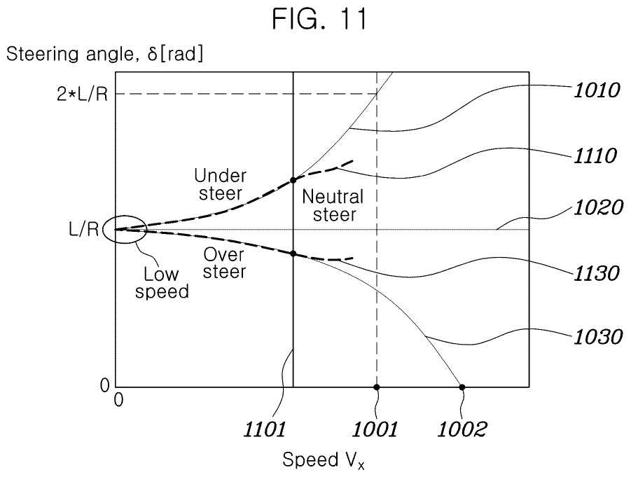

In order to compensate for the steering tendency of the vehicle, in the launch mode on the curved section, the torque vectoring control unit 170 may perform a torque vectoring control for differentiating a left-wheel torque and a right-wheel torque in a direction in which the steering tendency is offset, in consideration of the steering tendency of the vehicle. In the following description, the steering profile for the torque vectoring control unit 170 to perform the torque vectoring control according to the steering tendency of the vehicle are described with reference to FIGS. 10 and 11.

FIGS. 10 and 11 are diagrams illustrating torque vectoring control according to an embodiment of the present disclosure.

Referring to FIGS. 10 and 11, an understeer profile 1010, a neutral steer profile 1020 and an oversteer profile 1030 for describing a steering profile according to a steering tendency of the vehicle, a final understeer profile 1110 to which torque vectoring is applied, and a final oversteer profile 1130 to which torque vectoring is applied are shown.

The understeer profile 1010 may represent a steering angle corresponding to a vehicle speed of an understeer vehicle, the neutral steer profile 1020 may represent a steering angle corresponding to a vehicle speed of a neutral steer vehicle, and the oversteer profile 1030 may represent a steering angle corresponding to a vehicle speed of an oversteer vehicle, respectively.

Here, a characteristic speed 1001 may refer to a speed at which the steering angle of the vehicle is twice that of the steering angle in the neutral steer, and a critical speed 1002 may refer to a speed at which the steering angle of the vehicle becomes zero.

The final understeer profile 1110 represents a final steering profile that is set to perform the torque vectoring control from a torque vectoring vehicle speed 1101 for the understeer vehicle. In a case where the final understeer profile 1110 is applied to the vehicle, compared to the vehicle to which the understeer profile 1010 is applied, the understeer tendency may be reduced from the preset torque vectoring vehicle speed 1101.

The final oversteer profile 1130 represents a final steering profile that is set to perform the torque vectoring control from the torque vectoring vehicle speed 1101 for the oversteer vehicle. In a case where the final oversteer profile 1130 is applied to the vehicle, compared to the vehicle to which the oversteer profile 1030 is applied, the oversteer tendency may be reduced from the preset torque vectoring vehicle speed 1101.

In this case, the final understeer profile 1110 and the final oversteer profile 1130 may be generated based on the understeer profile 1010, the oversteer profile 1030 and the torque vectoring vehicle speed 1101.

For example, the torque vectoring control unit 160 may generate the final steering profile based on the steering profile generated in correspondence to the vehicle's steering tendency by the steering profile generation unit 130 and the torque vectoring vehicle speed 1101.

Here, the preset torque vectoring vehicle speed 1101 may be set so that the steering angle of the vehicle is less than the characteristic speed 1001 which is twice the steering angle in the neutral steering. Here, the torque vectoring vehicle speed 1101 is not necessarily set based on the characteristic speed 1001, and for example, may be set based on the critical speed 1002.

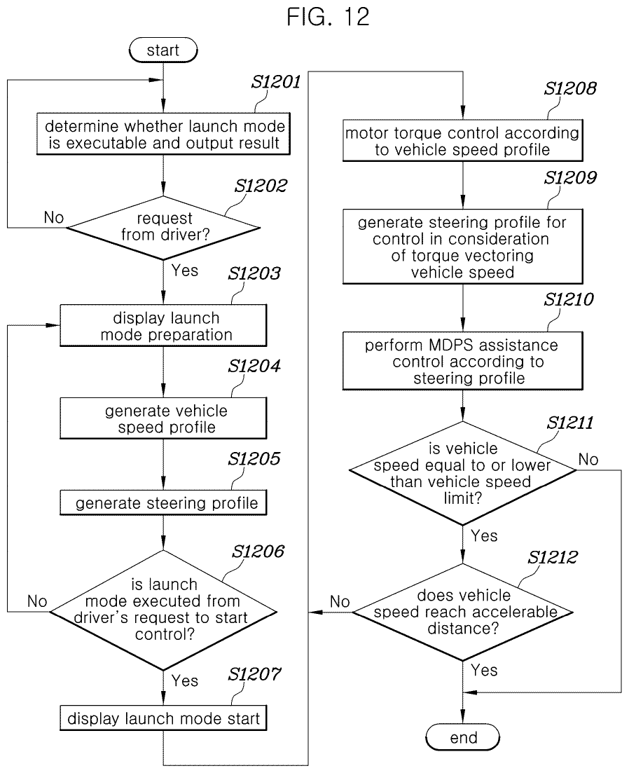

FIG. 12 is a flowchart showing a control process of a launch mode related to turning according to an embodiment of the present disclosure.

Referring to FIG. 12, the launch mode determination unit 110 may determine whether or not the launch mode related to turning is executable based on forward road situation information and a vehicle speed limit of the road ahead, and in a case where a determination is made that the launch mode is executable, the input/output control unit 140 may output the result through the input/output unit 400 (S1201).

Further, the input/output control unit 140 may receive a request from the driver to execute the launch mode through the input/output unit 400 (S1203). For example, the input/output control unit 140 may output whether or not to execute the launch mode to the display of the AVNT terminal 200 or to the cluster unit of the input/output unit 400, and may determine, in a case where the driver touches the display or cluster unit, that the request from the driver to execute the launch mode has been received. Here, the process of requesting to execute the launch mode and receiving the driver's request to execute the launch mode is provided by way of example, and the request to execute the launch mode may be made by a separate launch mode entry button operation.

In a case where there is the driver's request to execute the launch mode (Yes in S1202), the input/output control unit 140 may announce, via the input/output unit 400, that it is preparing to enter the launch mode (S1203). In addition, the vehicle speed profile generation unit 120 may generate the launch mode vehicle speed profile (S1204), and the steering profile generation unit 130 may generate the steering profile (S1205).

In a case where there is the driver's request to start the launch mode control (e.g., a request to start the launch control mode is provided) (Yes in S1206), the input/output control unit 140 displays the launch mode start related to turning through the input/output unit 400 (S1207), and the vehicle speed control unit 150 may perform the motor torque control according to the launch mode vehicle speed profile (S1208).

Specifically, in a case where the driver releases a brake pedal operation and starts an accelerator pedal operation (or in a case where the driver releases only the brake pedal operation in a state where the driver depresses both pedals), the input/output control unit 140 may determine that the driver's request to start the launch mode control has been received, and may send a command to the input/output control unit 140 and the acceleration control unit 150 to perform an operation related to the start of the launch mode control related to turning.

For example, in a case where information indicating that the driver operates the accelerator pedal by a preset value (for example, 70%) or more is received from an accelerator pedal sensor (APS), the input/output control unit 140 may determine that there is the driver's request to start the launch mode control (e.g., that a request to start the launch control mode is provided). As another example, in a case where the driver presses a “Cruise Resume” button while a cruise control system is activated, the input/output control unit 140 may determine that there is the driver's request to start the launch mode control (e.g., that a request to start the launch control mode is provided).

Here, the process of determining that there is the driver's request (e.g., that a request has been received) to start the launch mode control by the input/output control unit 140 is provided by way of example, and is not limited to the above-mentioned processes.

Further, the steering profile generation unit 130 may generate the final steering profile (S1209) in consideration of the torque vectoring vehicle speed, and perform an MDPS assistance control according to the final steering profile (S1210). For example, the steering profile generation unit 130 may generate the final steering profile based on the generated acceleration profile and steering profile and the torque vectoring vehicle speed. The steering control unit 150 may control the MDPS of the steering unit 600 based on the final steering profile. Here, in a case where a request is received from the driver to release the steering control assistance (e.g., through the driver's steering wheel operation), the MDPS assistance control may be terminated.

In addition, the input/output control unit 140 may determine whether the vehicle speed is equal to or lower than the vehicle speed limit (S1211), and may terminate the launch mode in a case where the vehicle speed exceeds the vehicle speed limit (No in S1211). Similarly, the input/output control unit 140 may determine whether the vehicle's driving distance has reached the accelerable distance (S1212), and may terminate the launch mode in a case where the vehicle's driving distance has reached the accelerable distance (Yes in S1212).

Compared to a other electrified vehicles, the electrified vehicle having such a launch mode may determine whether initial acceleration performance of the electrified vehicle can be used based on traffic situation information on a road ahead and a vehicle speed limit of the road ahead. Additionally, an electrified vehicle having a launch mode described herein may determine an acceleration profile capable of achieving the initial acceleration performance in a case where the initial acceleration performance can be used. Accordingly, even in a case where there is a curved section on a road, the electrified vehicle having the launch mode performs torque control corresponding to a vehicle speed profile and a final steering profile, thereby fully utilizing initial acceleration performance of the electrified vehicle and securing steering stability.

The above-described present disclosure may be implemented as a (e.g., non-transitory) computer-readable medium on which a program is written. The computer-readable medium includes all kinds of recording devices in which computer-readable data is stored. The computer-readable medium includes a hard disk drive (HDD), a solid state drive (SSD), a silicon disk drive (SDD), a ROM, a RAM, a CD-ROM, a magnetic tape, a floppy disk, an optical data storage system, etc.

As should be apparent from the above description, the following effects are achieved.

First, it is possible to provide an electrified vehicle with a launch mode related to turning and a control method thereof.

In addition, it is possible to provide an electrified vehicle capable of generating an acceleration profile in consideration of a vehicle speed limit and traffic situation information on a road ahead, and a control method thereof.

Further, it is possible to provide an electrified vehicle capable of performing torque vectoring control for a stable turning operation in a launch mode related to turning, and a control method thereof.

The effects obtained in the disclosure are not limited to the above-mentioned effects, and other effects not mentioned may be clearly understood by those of ordinary skill in the art to which the disclosure belongs from the description below.

Although embodiments of the present disclosure have been disclosed for illustrative purposes, those of ordinary skill in the art should appreciate that various modifications, additions and substitutions are possible, without departing from the scope and spirit of the disclosure as disclosed in the accompanying claims.

What is claimed is:

1. An electrified vehicle comprising:
a vehicle speed profile generation unit configured to, in a launch mode related to turning of a vehicle, generate a vehicle speed profile of the vehicle based on a vehicle speed limit of a road ahead and an upper limit value of acceleration of the vehicle;
a steering profile generation unit configured to generate a steering profile of the vehicle based on curvature information on the road ahead; and
a control unit configured to perform torque control of a drive motor of the vehicle based on the vehicle speed profile and steering control of the vehicle based on the steering profile,
wherein the control unit is configured to perform the torque control and the steering control from a starting point at which the vehicle starts acceleration to an ending point at which the vehicle reaches the vehicle speed limit.

2. The electrified vehicle according to claim 1, wherein the control unit is further configured to perform a torque vectoring control based on a steering tendency of the vehicle to differentially control a left-wheel torque and a right-wheel torque in a direction in which the steering tendency is offset.

3. The electrified vehicle according to claim 2, wherein the torque vectoring control is configured to be performed based on the vehicle reaching a preset torque vectoring vehicle speed.

4. The electrified vehicle according to claim 3, wherein the steering profile generation unit is configured to generate a final steering profile of the vehicle based on the steering profile and the torque vectoring vehicle speed.

5. The electrified vehicle according to claim 3, wherein the preset torque vectoring vehicle speed is set to be less than a characteristic speed at which a steering angle of the vehicle is twice a steering angle in a neutral steer state.

6. The electrified vehicle according to claim 1, further comprising:
a launch mode determination unit configured to determine whether the launch mode is executable based on route information on the road ahead, situation information on the road ahead, and the vehicle speed limit of the road ahead.

7. The electrified vehicle according to claim 6, wherein the launch mode determination unit is configured to determine that the launch mode is executable based on an accelerable distance according to the situation information being greater than a preset distance and the vehicle speed limit being greater than a preset vehicle speed.

8. The electrified vehicle according to claim 7, wherein the situation information includes at least one of forward traffic information received from an external source or forward obstacle information received through a sensor, and
wherein the preset distance and the preset vehicle speed are set based on a minimum distance and a minimum vehicle speed necessary for reaching a specific speed based on the vehicle accelerating from a stopped state.

9. The electrified vehicle according to claim 8, wherein the vehicle speed profile generation unit is configured to generate the vehicle speed profile so that an integral value of a vehicle speed on the vehicle speed profile from the starting point at which the vehicle starts acceleration in the launch mode to the ending point of the launch mode does not exceed the accelerable distance.

10. The electrified vehicle according to claim 6, further comprising:
an input/output unit that is configured to output information indicating that the launch mode is executable based on the launch mode determination unit determining that the launch mode is executable, and configured to receive a user's request to execute the launch mode.

11. A control method of an electrified vehicle comprising:
generating, by a vehicle profile generation unit in a launch mode related to turning of a vehicle, a vehicle speed profile of the vehicle based on a vehicle speed limit of a road ahead and an upper limit value of acceleration of the vehicle;
generating, by a steering profile generation unit, a steering profile of the vehicle based on curvature information on the road ahead; and
performing torque control of a drive motor of the vehicle based on the vehicle speed profile, and steering control of the vehicle based on the steering profile,
wherein the torque control and the steering control are performed by a control unit from a starting point at which the vehicle starts acceleration to an ending point at which the vehicle reaches the vehicle speed limit.

12. The control method according to claim 11, further comprising:
performing torque vectoring control based on a steering tendency of the vehicle to differentially control a left-wheel torque and a right-wheel torque in a direction in which the steering tendency is offset.

13. The control method according to claim 12, wherein performing the torque vectoring control is performed based on the vehicle reaching a preset torque vectoring vehicle speed.

14. The control method according to claim 13, further comprising:
generating, by the steering profile generation unit, a final steering profile of the vehicle based on the steering profile and the torque vectoring vehicle speed after the torque vectoring vehicle speed is determined.

15. The control method according to claim 13, wherein the preset torque vectoring vehicle speed is set to be less than a characteristic speed at which a steering angle of the vehicle is twice a steering angle in a neutral steer angle.

16. The control method according to claim 11, further comprising:
determining whether the launch mode is executable based on route information on the road ahead, situation information on the road ahead, and the vehicle speed limit of the road ahead.

17. The control according to claim 16, wherein determining whether or not the launch mode is executable includes determining that the launch mode is executable based on an accelerable distance according to the situation information being greater than a preset distance and the vehicle speed limit being greater than a preset vehicle speed.

18. The control method according to claim 17, wherein the situation information includes at least one of forward traffic information received from a source external to the electrified vehicle or forward obstacle information received through a sensor, and
wherein the preset distance and the preset vehicle speed are set based on a minimum distance and a minimum vehicle speed necessary for reaching a specific speed based on the vehicle accelerating from a stopped state.

19. The control method according to claim 18, wherein generating the vehicle speed profile includes generating the vehicle speed profile so that an integral value of a vehicle speed on the vehicle speed profile from the starting point at which the vehicle starts acceleration in the launch mode to the ending point of the launch mode does not exceed the accelerable distance.

20. The control method according to claim 16, further comprising:
outputting information indicating that the launch mode is executable based on the launch mode determination unit determining that the launch mode is executable, and receiving a user's request to execute the launch mode, by the input/output unit.
